(19) United States
(12) Patent Application Publication
(10) Pub. No.: US 2020/0187485 A1
(43) Pub. Date: Jun. 18, 2020

(54) Trap and its use for killing animals

(71) Applicant: Karen Elisabeth DAMGAARD JENSEN, Laval, Quebec (CA)

(72) Inventor: Karl Johan DAMGAARD JENSEN, Odense NV (DK)

(21) Appl. No.: 16/644,536

(22) PCT Filed: Aug. 31, 2018
(86) PCT No.: PCT/EP2018/073444

§ 371 Date: Mar. 5, 2020

(30) Foreign Application Priority Data
Sep. 5, 2017 (DK) PA 2017 70665

(51) Int. Cl. A01M 23/30

(52) U.S. Cl. CPC A01M 23/30; A01M 2200/00

(57) ABSTRACT

By providing a trap with a trigger mechanism, according to the invention, which comprises a stiff connecting member (10), which the animal (8) affects when it is located in a room (6) underneath bait (7), a high degree of accuracy of strike is achieved as the plunger (2) is not released until the animal (8) is located inside the room (6).

### PRIOR ART

The invention relates to a trap for killing animals, such as rodents, comprising a cabinet with an entrance to a room in which bait is accessible and where there is a contact organ, which by contact of the animal releases a plunger, which moves through the room by means of spring force and kills the animal after which the plunger retrieves to a loaded position by means of an actuator driven by an electric motor, the plunger being released from a loaded position via a trigger mechanism comprising a projection, an edge on the outside of the plunger, the projection/edge, being abut a trigger mechanism/rocker arm, which is moved away from the projection, when the contact organ is touched.

Traps of this kind are known in various configurations. What they all have in common is that they kill the animal by means of a plunger, which is released momentarily and with a plunge impact kills the animal.

Examples of this are described in U.S. Pat. Nos. 2,183,926 and 1,249,337.

These known traps make use of spring force as propellant for moving the plunge across the room in which the animal is located.

After the plunge has killed the animal, it is retrieved to its starting position, either manually or by means of an electric motor upon each plunge.

Traps as described in U.S. Pat. Nos. 2,183,926 and 1,249,337 are configured to kill the animal by the release of a shooting plunge when the animal is located on a bottom, a floor, and where the killed animal must be removed before the trap can function again.

Furthermore, in the trap of U.S. Pat. No. 1,249,337 the plunger must be manually loaded after each plunge, before being functional again.

Both traps are provided with bearing plates, which by contact of the weight of the animal release the plunger when the animal strains the plate.

However, this release mechanism does not always guarantee success, as the strain of the bearing plate is not equivalent to the animal being located in the room. There will be instances where the animal manages to escape, when contact takes place before the animal is in the position where it will be struck by the plunger.

U.S. Pat. No. 2,183,926 describes an electrically driven loading of the release spring 36, by means of a relatively complicated and thus operationally unstable mechanism.

The trap described in WO 2001/068121 A1 relates to an upper hinged punch plate, which is not suitable for killing rats in particular, as these from experience manage to escape before the plate has swung down and hit the animal, as the animart ability to react is exceptionally high. Further, the trap must be retrieved after each hit by the means of an electric actuator, which turns an arm on the outside of the trap, which, however, requires a long actuator piston travel.

Finally, from U.S. Pat. No. 9,615,566 B2 is known a trap with a piston stroke 3, which runs in a cylinder 10 and by means of compressed air in a cartridge 2 drives the plunger when this is released by the help of a trigger arm 18, which opens a valve 23. However, this trap has limited capacity and requires frequent inspection to ensure that adequate compressed air is available.

### OBJECT OF THE INVENTION

The object of the invention is to remedy these shortcomings and drawbacks of the known traps, and to ensure the best possible efficiency in regard to accuracy of strike, as rats in particular are very anxious and react to the smallest sound from the trap, including the trigger mechanism, which therefore must be completely silent and quick enough for the rat not to manage to escape, and it must be certain that the animal is located in the correct position when the plunger strikes.

This objective is reached according to the invention by means of a trigger mechanism, which comprises a stiff connecting member, which runs from the area underneath the bait and to one end of the rocker arm and where the opposite end in a loaded position abuts the projection.

In this surprisingly simple way, the trap will achieve a high effect and thereby efficiency due to the certainty of the position of the animal and the silent trigger mechanism, which does not require maintenance or inspection of any kind.

By configuring electric contact points on both the plunger and the wall, as described in claim 2, current pulse for killing will be provided, which in practice can be of significance, especially in respect of larger animals.

Finally, as described in claim 3, it is appropriate to use the trap either freely hung on a building or built into a sewer pipe or in sewers, when the entrance to the room is turned downward, so that the animal after the killing will fall down and make the trap ready again.

### THE DRAWING

In the following an example of an embodiment will be described in reference to the drawings, where

FIG. 1 shows the trap in its non-activated position

FIG. 2. shows the trap in its activated position

### DESCRIPTION OF AN EMBODIMENT

As shown in the drawings, the trap is built into a cabinet 1, which encases the mechanism.

In the cabinet 1 a plunger 2 is embedded, which by its movement is adapted for hitting a rats 8 head with the end plate of the plunger and thereby killing it.

The plunger 2 is affected in the direction of the movement by a powerful compression spring 3, which abuts a steady part 4 in the cabinet 1.

In general, positioning a powerful compression spring between a stationary surface at one end of the plunger and a moving front end of the plunger provides a powerful, compact and very simple i.e. the trap has very few moving parts. According to embodiments of this general construction, the spring may extend in the same direction as the plunger and extend in the direction of movement of the plunger head, ‘A stationary surface_indicates that the surface is stationary relative to the cabinet. In a preferred embodiment the plunger may at least partly constitute a cabinet or enclosure for the compression spring. In a preferred embodiment release of the spring e.g. a compression spring, the spring extends between a stationary surface and the plunger head thereby providing optimal speed and power of the plunger head. A compression spring is a spring e.g. of coil type offering resistance to a force tending to compress the spring, i.e. the spring is loaded by compression, whereas a tension spring or an extension spring e.g. a coiled spring offers resistance to a force pulling in direction of its length, i.e. the spring is loaded when extended.

The cabinet 1 is closed apart from an opening 5 at the bottom, which forms the entrance to a room 6, which room at the top gives access to the bait 7.

This bait 7 can be either a feed or an aromatic agent in firm or fluid form. The only condition is that it must be long-lasting and suitable for luring animals, such as a rat 8, into the room 6.

In order to place the bait 7, there is a flap 9 shown on top of the cabinet 1, which gives access to the bait room.

A mesh, a grill or the like may be placed between the bait room and the room 6 for the rat 8.

Furthermore, a contact organ 10 is placed underneath the bait 7, the contact organ may be a stiff mechanical connection, providing a mechanically connection to one end of a trigger arm e.g. in the shape of a rocker arm 11, which is fixed in a rocking point 11a. That the contact organ is stiff means that the contact organ has a low degree of flexibility and when the end of the contact organ which is placed underneath the bait moves, then the other or opposite end of the contact organ also moves correspondingly thereby providing a turning movement of the rocker arm 11. I.e. the stiffness of the contact organ provides a direct movement of the rocker arm and therefore also provides a simple and reliable activation mechanism.

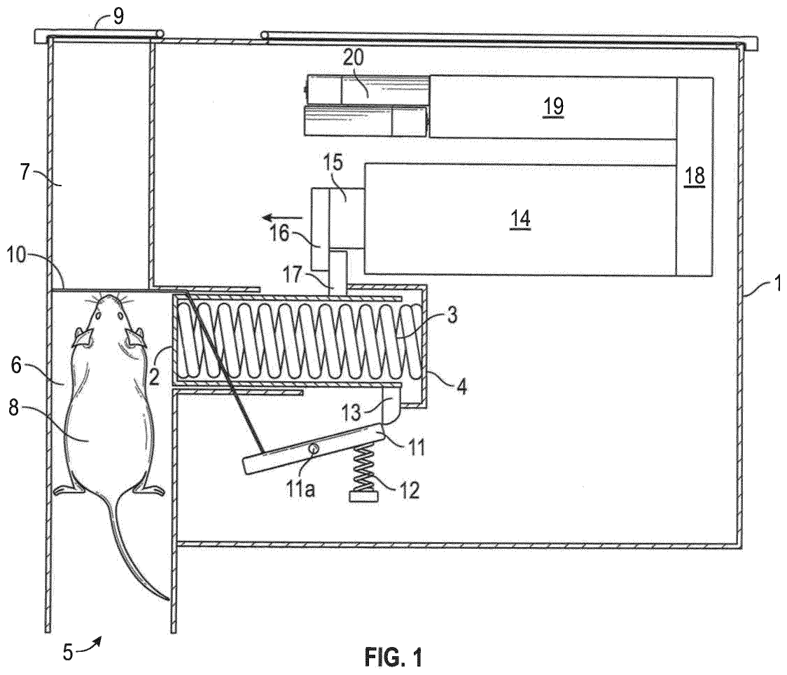

The arm 11 is spring-loaded at its other end by means of a compression spring 12, which holds the arm 11 in the position, which is shown in FIG. 1. This is the so-called loaded position.

The end of the arm 11 holds back a tap 13 of the plunger 2 and thereby prevents it, and thereby the plunger 2, from being moved by the spring 3.

When a rat touches the contact organ 10, the arm 11 is tilted by which the tap 13 is released, whereby the plunger 2 is being shot towards the rat 8 by means of the spring 3.

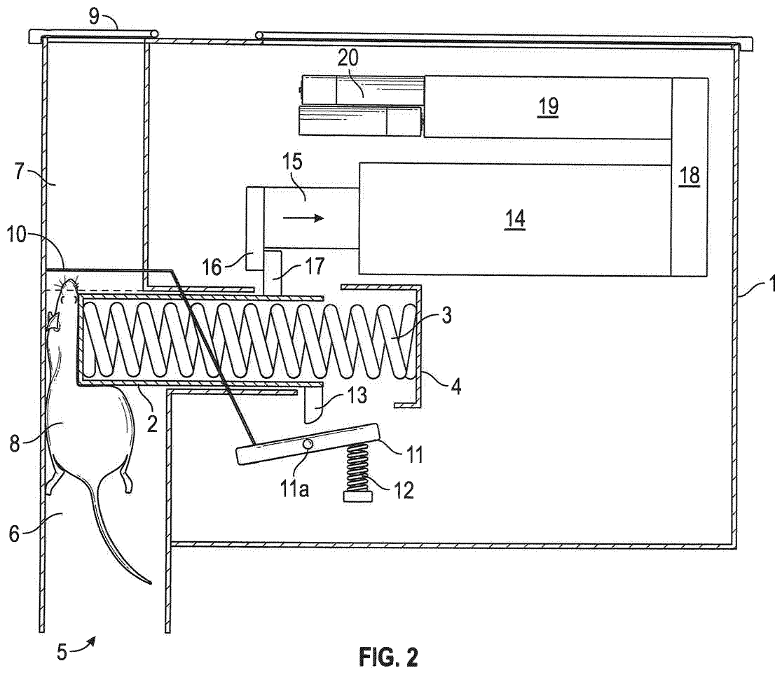

Thus, after the plunger 2 by impact of the contact organ 10 is led to the most forward position by the spring force, as shown in FIG. 2, the plunger 2 must be retrieved to the shown position in FIG. 1.

This takes place by means of an actuator 14 with a slider 15, which is provided with a carrier 16, which abuts a tap 17, which is fastened to the plunger 2.

The actuator 14 is driven via a driver 18 of an electric motor 19, which is supplied with current from batteries 20. These can be rechargeable and can thereby be charged by not-shown solar cells.

Lastly, an electric pulse supplier may be installed in the form of not-shown electrodes or contact spots on the plunger 2 and the opposite wall in the room 6.

The Functioning of the Trap will be Described in the Following.

In the passive loaded position of the trap, as shown in FIG. 1, the plunger 2 is in its retrieved position, where it is held by the trigger 11, which abuts the projection 13 on the plungers 2 underside.

When a rat 8, lured by the smell of the bait 7, finds its way via the opening 5, it will be led by the smell up towards the contact organ 10, which is located between the rat 8 and the bait 7.

When the rat 8 attempts to reach the bait 7, it will activate the contact organ 10, which thereby is slightly lifted, by which the tap 13 on the plunger 2 is released. This is shown in FIG. 2, which shows that the plunger 2 is moved forward by the spring 3 and has killed the rat 8.

Hereafter, the actuator will be activated and the plunger 2 will be retrieved by means of the carrier 16 which—against the spring force of the spring 3—is retrieved to its starting position, where the trigger arm 11 is lifted by the spring 12 and abuts the tap 13 and thereby holds the plunger 2 in its loaded position, where the trigger arm 11 holds back the projection 13, as shown in FIG. 1.

The rat 8 will then fall out of the trap, which is then ready for use as a trap again.

The trap can be installed on a part of a building or in a sewage system.

When the trap is installed in a sewer pipe, some kind of ladder system must be provided from the bottom of the sewer pipe and up to the trap, which is installed at the top of the pipe.

This ladder system may e.g. be in the form of a pipe, which runs from the sewer pipeš bottom and up to the opening of the trap 5. Via this pipe, the rat—lured by the smell from the bait 7—will climb up the pipe and into the room 6 of the trap.

The trap will not require maintenance in terms of bait, or current supply, which is why it is cost effective in service, and efficient and reliable in its capacity as a trap.

1. A trap for killing animals, such as rodents, comprising a cabinet (1) with an entrance (5) to a room (6) from which bait (7) is accessible and where there is a contact organ (10), which by contact of the animal releases a plunger (2), which moves through the room (6) by means of spring force (3) and kills the animal (8) after which the plunger (2) is retrieved to loaded position by means of an actuator (14) driven by an electric motor(19), the plunger (2) is being released from a loaded position via a trigger mechanism comprising a projection, an edge (13), on the outside of the plunger (2), which projection/edge,(13) abuts a trigger mechanism/rocker arm (11), which is moved away from the projection (13), when the contact organ (10) is affected, characterized in that the contact organ (10) consists of a stiff connecting member, which extends from the top of the room (6) under the bait (7) and to the one end of the rocker arm (11) and where the opposite end in loaded position abuts the projection (13).

2. A trap according to claim 1, characterized in that the plunger (2) and the wall of the room (6) are conductive for conducting an electric current when the plunger (2) contacts the animal upon release.

3. Use of the trap, according to claim 1, characterized in that the trap is mounted with the entrance (5) to the room (6) from below.
